(19) United States
(12) Patent Application Publication
(10) Pub. No.: US 2008/0271041 A1
(43) Pub. Date: Oct. 30, 2008

(54) PROGRAM PROCESSING METHOD AND INFORMATION PROCESSING APPARATUS

(75) Inventor: Ryuji Sakai, Hanno-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/103,973

(22) Filed: Apr. 16, 2008

(30) Foreign Application Priority Data
Apr. 27, 2007 (JP) 2007-119839

(51) Int. Cl. G06F 9/46

(52) U.S. Cl. 718/107

(57) ABSTRACT

According to one embodiment, a program processing method includes converting parallel execution control description into graph data structure generating information, extracting a program module based on preceding information included in the graph data structure generating information when input data is given, generating a node indicating an execution unit of the program module for the extracted program module, adding the generated node to a graph data structure configured based on preceding and subsequent information defined in the graph data structure generating information, executing a program module corresponding to a node included in a graph data structure existing at that time, by setting values for the parameter, based on performance information of the node when all nodes indicating a program module defined in the preceding information have been processed, and obtaining and saving performance information of the node when a program module corresponding to the node has been executed.

### CROSS-REFERENCE TO RELATED APPLICATIONS

This application is based upon and claims the benefit of priority from Japanese Patent Application No. 2007-119839, filed Apr. 27, 2007, the entire contents of which are incorporated herein by reference.

### BACKGROUND

1. Field

One embodiment of the invention relates to program processing, and in particular to program processing for parallel processing.

2. Description of the Related Art

In conventional multi-thread parallel processing, a plurality of thread is generated, and each thread is forced to programming assuming synchronous processing. For example, it is necessary to disperse processing ensuring synchronization at several positions in a program, in order to keep the order of execution appropriate. This complicates program debugging, and increases maintenance costs.

Jpn. Pat. Appln. KOKAI Publication No. 2005-258920 discloses a method of realizing parallel processing based on a result of execution of a thread and a dependent relationship between threads, when a plurality of thread is generated. In this method, it is necessary to previously and quantitatively define a thread that is redundantly executed. This arises a problem that flexibility of program changing is lost.

It is necessary to previously determine a dependent relationship between programs or between threads for parallel processing of programs by keeping an appropriate execution order. It is also preferable to provide a scheme to dynamically adjust the load of execution of each program, according to occasional situations.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a system configuration according to an embodiment of the invention;

FIG. 2 is an exemplary diagram showing translation of a program according to the embodiment;

FIG. 3 is an exemplary diagram showing a flow of processing a conventional parallel processing program;

FIG. 4 is an exemplary diagram explaining a method of dividing a program according to the embodiment;

FIG. 5 is an exemplary diagram explaining a dependent relationship between nodes according to the embodiment;

FIGS. 6A and 6B are exemplary diagrams explaining a node according to the embodiment;

FIG. 7 is an exemplary diagram showing graph data structure generating information of a node according to the embodiment;

FIG. 8 is an exemplary flowchart showing additional processing of a graph data structure according to the embodiment;

FIG. 9 is an exemplary flowchart showing processing of a basic module according to the embodiment; and

FIG. 10 is an exemplary flowchart showing a procedure of determining parameters by performance information during processing of a basic module according to the embodiment.

### DETAILED DESCRIPTION

Various embodiments according to the invention will be described hereinafter with reference to the accompanying drawings. In general, according to one embodiment of the invention, a program processing method includes converting parallel execution control description into graph data structure generating information, extracting a program module based on preceding information included in the graph data structure generating information when input data is given, generating a node indicating an execution unit of the program module for the extracted program module, adding the generated node to a graph data structure configured based on preceding and subsequent information defined in the graph data structure generating information, executing a program module corresponding to a node included in a graph data structure existing at that time, by setting values for the parameter, based on performance information of the node when all nodes indicating a program module defined in the preceding information have been processed, and obtaining and saving performance information of the node when a program module corresponding to the node has been executed.

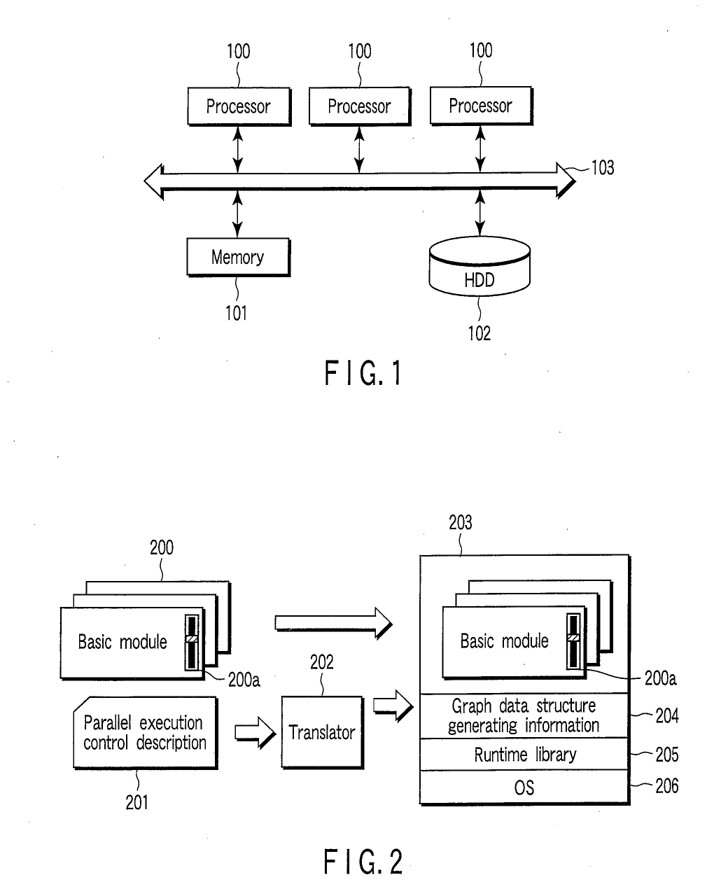

FIG. 1 is an exemplary diagram showing a system configuration according to the embodiment. FIG. 1 shows processors 100, a memory 101, a HDD 102, and an internal bus 103.

The processor 100 has a function of interpreting program code stored in various storage units and executing a process previously described as a program. In FIG. 1, three equivalent processors 100 are shown, but they may not be equivalent processors, and may have different capacity and capability of processing different kinds of code.

The memory 101 indicates a storage unit composed of a semiconductor, for example. A program processed by the processor 100 is previously read into the memory 101 accessible at a relatively high speed, and accessed by the processor 100 during execution of a program.

The HDD 102 indicates a magnetic disc unit, for example. The HDD 102 can store a large amount of data, compared with the memory 101, but the access speed is lower. Program code processed by the processor 100 is previously stored in the HDD 102, and only a processing part is read into the memory 101.

The internal bus 103 is a common bus configured to connect the processor 100, memory 101 and HDD 102, to transfer data among them.

The system may be provided with a not-shown image display to output the processing result, or an input/output unit such as a keyboard to input processing data.

FIG. 2 is an exemplary diagram showing translation of a program according to the embodiment.

A basic module 200 is a program to be executed by the system according to the embodiment. The basic module 200 is configured to receive more than one parameter 200a, and adjust the load of execution by changing an algorithm in use or by changing threshold values and coefficients in an algorithm.

A parallel execution control description 201 is data to be referred to during execution of a program. The parallel execution control description 201 indicates a dependent relationship between basic modules 200 during parallel processing, and is converted to graph data structure generating information 204 by a translator 202 before execution by the information processing system 203.

The translator 202 may be used by a runtime task, etc. for sequential translation during execution of the basic module 200, in addition to previous conversion before processing the basic module 200.

Software at an execution point in the information processing system 203 consists of the basic module 200, the graph data structure generating information 204, a runtime library 205, and an OS 206. The runtime library 205 includes an application program interface (API) used when the basic module 200 is executed in the information processing system 203, and has a function of realizing an exclusive control necessary for parallel processing of basic modules 200. On the other hand, the software may be configured to call up the function of the translator 202 from the runtime library 205, and to convert the parallel execution control description 201 of a part to be next processed at each time, whenever called up in the course of processing the basic module 200.

The OS 206 manages the entire system, including the hardware of the information processing system 203 and scheduling of task.

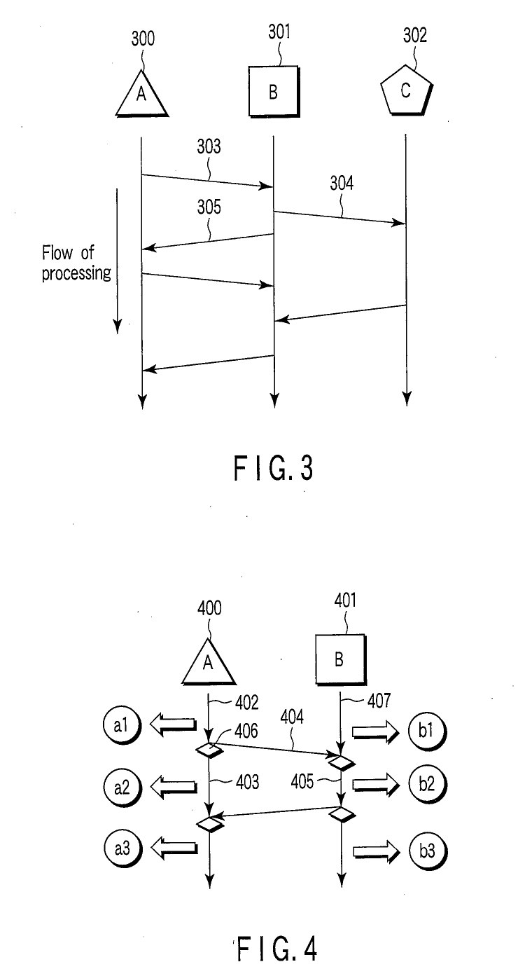

FIG. 3 is an exemplary diagram showing a flow of processing a conventional parallel processing program. FIG. 3 shows a schematic diagram of parallel processing of programs A300, B301 and C302.

The programs are not independently processed. When using processing results of other programs, or ensuring data integrity, each program must wait until a specific part of another program is executed. When processing programs with such characteristics in parallel, it is necessary to embed a scheme to know execution states of other programs at several locations in a program. By embedding such a scheme, heretofore, a program is configured to ensure data, realize exclusive control, and cooperate each other.

For example, when a predetermined event occurs during processing of the program A300, the program A300 requests the program B301 to take any action (event 303). Receiving the event 303, the program B301 executes predetermined processing, and when a predetermined condition is established, issues an event 304 for the program C302. By the event 303, the program B301 replies the processing result received from the program A300 to the program A300, as an event 305.

However, when a program itself is written to realize synchronous processing in parallel processing, consideration is required in addition to primary logic, and a program becomes complex. During the time waiting for the end of another program, resources are wastefully consumed. Further, the processing efficiency is largely fluctuated by a slight shift in timing, and later program modification becomes difficult.

In the information processing system according to this embodiment, a method for acceleration component-based design of a basic module and compact management of parallel processing definition is proposed, by dividing synchronous processing and data transfer at necessary portions, and defining the relation between them as parallel execution control description. A method of dynamically adjusting a load of execution of each basic module configured as a component is also proposed.

FIG. 4 is an exemplary diagram explaining a method of dividing a program according to this embodiment. FIG. 4 shows programs A400 and B401, which execute synchronous processing to each other.

It is assumed that the program A400 executes a thread 402, and the program B401 executes a thread 407. It is assumed that when the program A400 is executed up to a point 406, the processing result needs to be transferred to the program B401. After executing the thread 402, the program A400 informs the program B401 of the processing result as an event 404. The program B401 can execute a thread 405 only when the processing results of the event 404 and thread 407 are obtained. After the thread 402 is processed, the program A400 executes programs subsequent to the point 406 as a thread 403.

The above thread 402 is a part that can be unconditionally processed. At the point 406, a processing result to be notified to another thread during execution of a program can be obtained. There are other points requiring a processing result from another thread as a condition to start processing.

As shown in FIG. 4, a program is divided at a point such as a point 406, and units of processing a program after the division are defined as basic modules a1-a3 and basic modules b1-b3. FIG. 4 shows two programs associated with each other. Even if there are two or more related programs at the time of configuring a program, the programs can be divided based on the same idea.

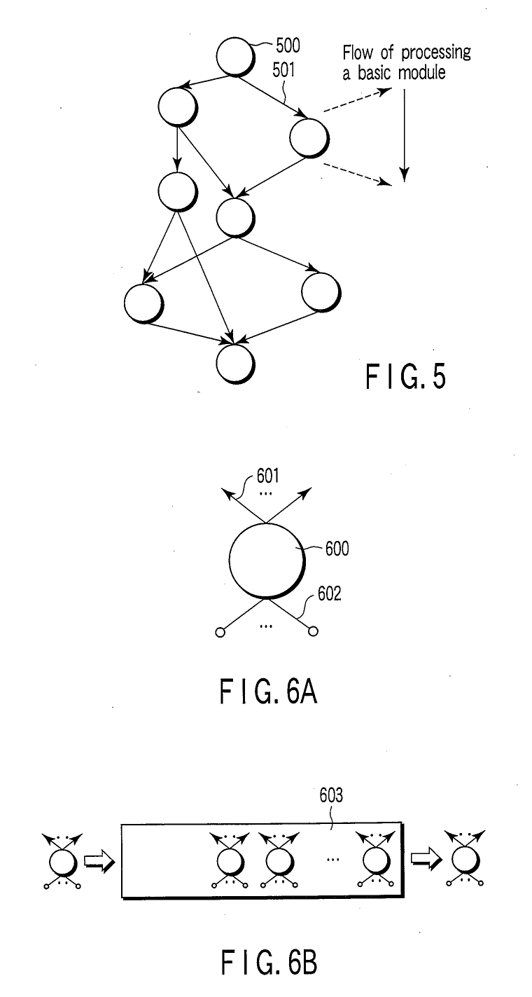

FIG. 5 is an exemplary diagram explaining a dependent relationship between basic modules according to this embodiment. A basic module 500 is a basic module explained in FIG. 4, to which a module-based program executable unconditionally and independently of other threads is assigned. This module-based program corresponds to the basic module 200. These basic modules are related by a link 501 indicating a dependent relationship between other basic modules. Each basic module receives calculation result output data from a preceding basic module defined as related by the link 501, as an input, and writes the data into a subsequent basic module defined as related by the link 501. A basic module receiving two or more links indicates that two or more input data are necessary for that module itself.

FIGS. 6A and 6B are exemplary diagrams explaining a node 600 according to this embodiment. A node mentioned here corresponds to an individual basic module, in which a basic module is designed as a graph data structure based on graph data structure generating information 204, after the parallel execution control description 201 is converted to the graph data structure generating information 204 by the translator 202.

The node 600 as a graph structure of a basic module has a dependent relationship with other nodes by a link. Viewing as a node as shown in FIG. 6A, there are two kinds of link, a link 601 to preceding nodes, and a connector 602 to subsequent nodes.

The link 601 is connected to an output end of another node required to obtain data necessary for the node 600 to execute predetermined processing. The link 601 has definition information to indicate which output end is to be linked.

The connector 602 has identifying information to identify data to be output after the node 600 finishes processing. Subsequent nodes can judge whether the executable conditions are established, based on the identifying information of the connector 602 and parallel execution control description 201.

When the executable conditions are assumed established by the runtime library, the node 600 is queued to an executable queue 603 in units of node as shown in FIG. 6B, and a node to be next executed is taken out of the queued nodes, and executed.

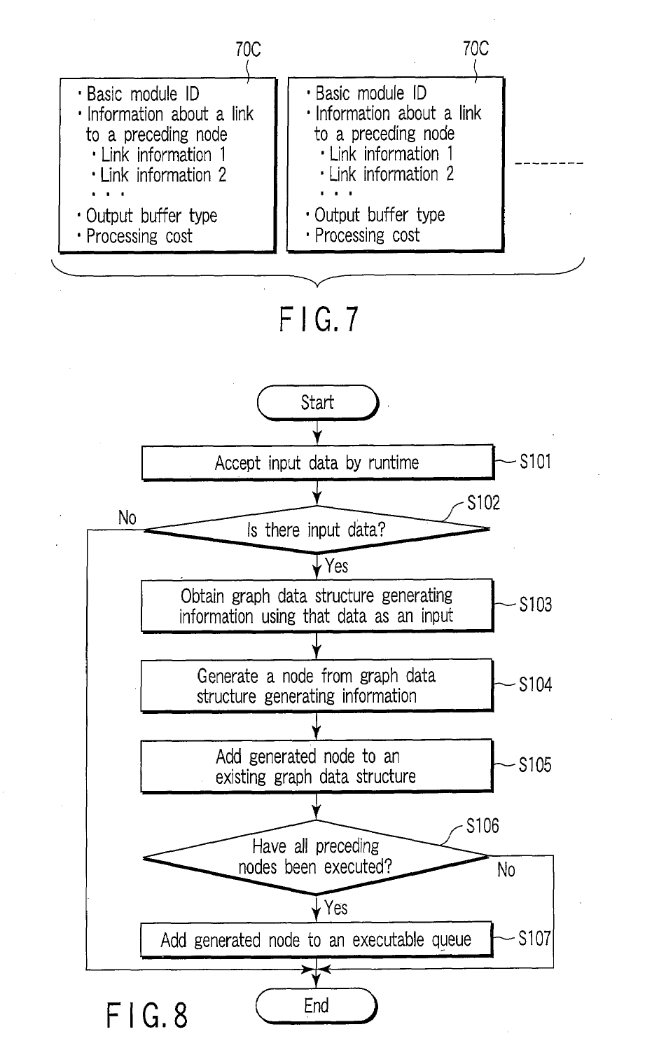

FIG. 7 is an exemplary diagram showing the node graph data structure generating information 204 according to this embodiment. FIG. 7 shows graph data structure generating information 700 translated from the parallel execution control description 201. The graph data structure generating information 700 includes a basic module ID, information about a link to a preceding node, a kind of an output buffer of that node, and node processing costs. The cost information mentioned here indicates the costs of processing the basic module 200 corresponding to that node. This information is considered when selecting a node to be taken out next among the nodes queued to the executable queue 603.

The information about a link to a preceding node defines conditions of a node that is to become a preceding node of that node. For example, a node to output a predetermined data type or a node having a specific ID is defined.

The graph data structure generating information 700 expresses the corresponding basic module 200 as a node, and is used as information to add this basic module to an existing graph data structure as shown in FIG. 5, based on the link information.

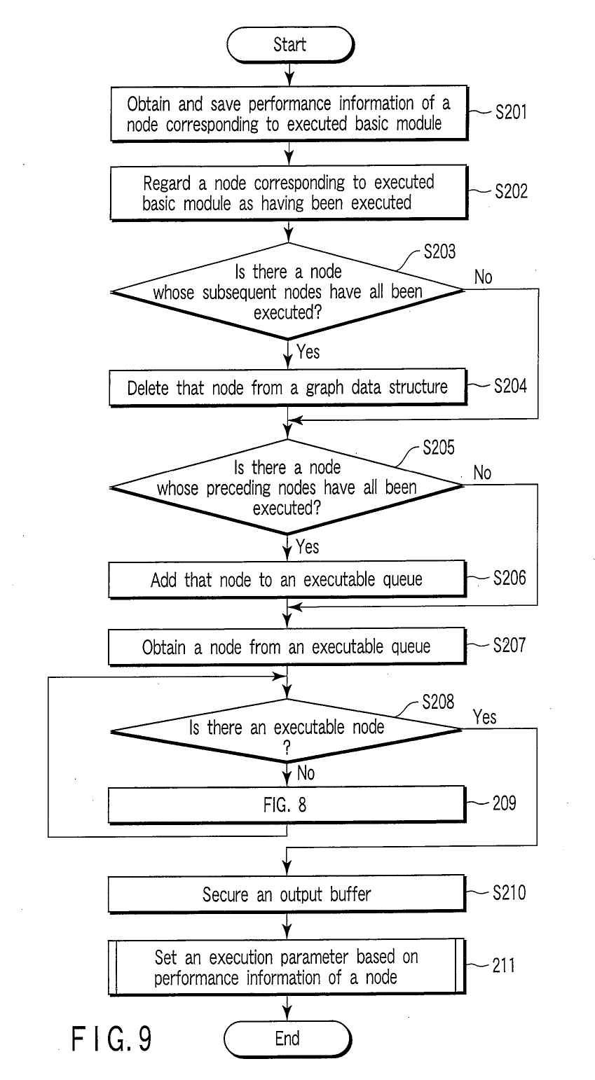

FIG. 8 is an exemplary flowchart showing additional processing of a graph data structure according to this embodiment. When this flow is executed, if a preceding node has been executed, a node executable at each time is generated based on the graph data structure generating information 700, and the generated node is queued to the executable queue 603.

The runtime library managing multi-thread processing accepts input data to be processed (block S101). The runtime library sets the operation environment to be called up from each core to execute multi-thread processing. Therefore, a parallel program can be captured as a model operated mainly by a core, not a model operated mainly by runtime, and a queue for synchronization in parallel processing can be reduced by decreasing the runtime overhead. If the operation environment is configured so that only one runtime task calls up a basic module, a task to execute a basic module and a runtime task are frequency switched, and the overhead is increased. A runtime task judges existence of input data (block S102), and when there is no input data (No in block S102), terminates this processing flow.

When there is input data (Yes in block S102), a runtime task extracts the graph data structure generating information 204 taking this input data as an input, and obtains them (block S103). The output data of basic module 200 is previously divided into several types to be described in the types of output buffer of the graph data structure generating information 700. When the graph data structure generating information 204 using the input data as an input is extracted, the information whose data type matches the input data is extracted, based on the data type that is to be the input data included in the information about the link to a preceding node described in the graph data structure generating information 700.

Next, the node 600 corresponding to the graph data structure generating information 700 obtained in block S103 is generated (block S104). When two or more graph data structure generating information 700 are extracted, the node 600 corresponding to each of these graph data structure generating information is generated.

The generated node 600 is added to an existing graph data structure (block S105). The existing graph data structure mentioned here is a structure of a dependent relationship before/after generated nodes as shown in FIG. 5, for example, based on the output buffer type and the information about the link to a preceding node of the node 600 generated from the graph data structure generating information 700.

Next, whether processing of each node corresponding to a node preceding to the added node, included in the existing graph data structure, is judged completed or not (block S106). When all preceding nodes are completed for a certain node (Yes in block S106), conditions for starting execution of this node are regarded as established, and this node is queued to the executable queue 603 (block S107).

In contrast, when there is a preceding node not completely processed (No in block S106), the processing of this node cannot be started, and the flow is terminated. As described above, even if the node 600 is generated, the basic module 200 corresponding to that node is not immediately executed, and the execution is held until a dependent relationship with other added nodes of the graph data structure is satisfied.

FIG. 9 is an exemplary flowchart showing an example of processing of a basic module according to this embodiment. This flowchart shows an example of reading nodes queued to the executable queue 603 and executing each basic module 200.

First, the performance information of the executed basic module 200 is obtained and saved (block S201), and the executed flag of that node in the graph data structure is set to “processed” (block S202).

Whether all subsequent nodes included in the graph data structure of that node have been processed is judged (block S203). When all subsequent nodes have been processed (Yes in block S203), that node can be deleted from the graph data structure (block S204). At this time, as the output data of that node is not used, the output buffer secured is released. In contrast, when subsequent nodes include one not yet processed, the output data of that node may be used in the basic module of a subsequent node, and must not be deleted from the graph data structure.

Whether all preceding nodes have been processed for each of all nodes included in the graph data structure is judged (block S205). When there is a node whose all preceding nodes have been processed (Yes in block S205), that node is regarded as having established execution start conditions, and queued to the executable queue 603 (block S206). For a node whose preceding nodes include one not yet processed, whether that node is processed is judged again at the end of processing the preceding nodes.

Next, a next processing node is selected from executable nodes queued to the executable queue 603, based on predetermined conditions (block S207). The predetermined conditions include an oldest node queued, a node with many subsequent nodes, and a costly node, for example. The cost of each node may be calculated by the following equation.

$$Cost of added node = ( α \times Past average execution time ) + ( β \times Output buffer use amount ) + ( γ \times Number of subsequent nodes ) + ( δ \times Frequency of nonscheduled execution )$$

Generally, a throughput of parallel processing is increased by processing nodes sequentially from a higher cost node. The frequency of nonscheduled execution means the frequency of a situation that no node is queued to the executable queue 603 during execution of its basic module. This situation means that an underflow occurs in the executable queue 603, and is not preferable because the efficiency of parallel processing of the basic module 200 is lowered. As the basic module 200 under execution at this time is calculated at a higher cost, it is processed early, and an effect to prevent a bottleneck can be expected.

Coefficients α-δ in the linear expression of the above cost calculation equation may use predetermined values, or may be configured to dynamically change while monitoring the processing situation.

If executable node is not exists (No in block S208), the process of FIG. 8 is performed (block S209). On the other hand (Yes in block S208), an output buffer to store the processing result of this node is secured before execution of the node (block S210). The output buffer is secured based on the definition of output buffer types defined by the graph data structure generating information 700.

After the output buffer is secured, values of more than one parameter receivable by the corresponding basic module is set, based on the performance information obtained at the time of the previous execution of basic module corresponding to that node and saved (block S211). As a result, execution of the basic module 200 corresponding to this node is started.

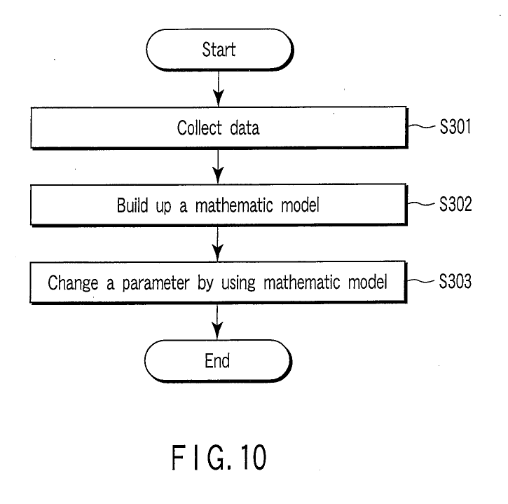

In block S201, a set of parameters and execution time of the processed basic module 200 is recorded as performance information. The principle of determining parameters from this performance information in block S211 will be explained by referring to the flowchart of FIG. 10.

First, performance data such as quality of generated data and execution time is collected by changing parameters of each module (changing in the direction to decrease a default value and load) while keeping the real-time restrictions, by using the information about the execution time of each module (block S301). Collection of this performance data is executed by the number of times until obtaining least minimum data to build up a mathematic model.

Then, a mathematic model is built up based on the obtained performance data (block S302). This equation expresses a parameter having an influence on the quality of generated data and execution time of a program, and is basically a linear expression, but sometimes, the terms of second and third degrees are demanded.

The quality of generated data and execution time are expressed as follows, for example.

$$Quality of generated data = ( A \times Parameters of Basic module ( 1 ) ) + ( B \times Parameters of basic module ( 2 ) ) + … Execution time = ( α \times Parameters of Basic module ( 1 ) ) + ( β \times Parameters of Basic module ( 2 ) ) + …$$

According to the mathematic model built up as above, whether there is an allowance is judged from the system CPU use rate and program execution time, and parameters are changed (block S303). For example, when there is an allowance in the execution time, a parameter of the module of the term having the largest influence on the quality are changed. When there is no allowance in the execution time, a parameter having no influence on the quality but having a large influence on the execution time are changed.

Each time program generation data is obtained, blocks S302 to S303 are basically executed. However, when buffering has an allowance in stream processing, the blocks may be executed at a longer interval. A speed may be estimated each time a basic module is executed.

In the above configuration, a runtime task independently selects an executable basic module 200, and sequentially updates the graph data structure, thereby executing parallel processing. Therefore, a series of such processing need not be considered as an application. Further, the basic module 200 does not include a part branched from other tasks, and adjustment is unnecessary for other tasks in execution. It is also possible to realize a scheme that dynamically adjusts an execution load of each program according to the circumstances.

Therefore, it is possible to provide a programming environment, in which a program can be created without considering parallel processing, and can be flexibly executed even in multi-thread parallel processing.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A program processing method for parallel processing of program modules which are executed independently of execution situations of other programs on condition that input data is prepared, and which are operated based on values of more than one parameter settable at each time of execution, the method comprising:
converting parallel execution control description describing a relationship of parallel processing among the program modules, for each of the program modules, into graph data structure generating information including at least preceding and subsequent information of the program modules extracting a part related to each of the program modules;
extracting a program module which uses input data as an input based on preceding information included in the graph data structure generating information, when the input data is given;
generating a node indicating an execution unit of the program module for the extracted program module; adding automatically the generated node to a graph data structure configured based on preceding and subsequent information defined in the graph data structure generating information of nodes generated before that node;
executing a program module corresponding to a node included in a graph data structure existing at that time, by setting values for the more than one parameter, based on performance information of the node obtained and saved at the time of previous execution, when all nodes indicating a program module defined in the preceding information have been processed; and
obtaining and saving performance information of the node, when a program module corresponding to the node has been executed.

2. The program processing method according to claim 1, further comprising automatically deleting a node from the graph data structure, when all nodes extracted based on subsequent information of graph data structure generating information corresponding to the node have been processed.

3. The program processing method according to claim 1, wherein the converting the parallel execution control description into the graph data structure generating information including automatically performing for a part related to a program module executed by the program processing in the parallel execution control description.

4. An information processing apparatus comprising:
a storage unit to store program modules which are executed independently of execution situations of other programs on condition that input data is prepared, and which are operated based on values of more than one parameter settable at each time of execution; and
a processing unit configured to convert parallel execution control description describing a parallel processing relationship among the program modules, for each of the program modules, into graph data structure generating information including at least preceding and subsequent information of the program modules extracting a part related to each of the program modules,
the processing unit extracting a program module which uses input data as an input based on preceding information included in the graph data structure generating information, when the input data is given as a result of execution of the program module,
generating a node indicating an execution unit of the program module for the extracted program module,
adding automatically the generated node to a graph data structure configured based on preceding and subsequent information defined in the graph data structure generating information of nodes generated before that node,
executing a program module corresponding to a node included in a graph data structure existing at that time, by setting values for the more than one parameter, based on performance information of the node obtained and saved at the time of previous execution, when all nodes indicating a program module defined in the preceding information have been processed, and
obtaining and saving performance information of the node, when a program module corresponding to the node has been executed.
